(19) United States
(12) Patent Application Publication
(10) Pub. No.: US 2010/0163496 A1
(43) Pub. Date: Jul. 1, 2010

(54) METHOD AND APPARATUS FOR REMOVAL OF SOOT FROM LUBRICATING OIL

(76) Inventor: Gerard W. Bilski, Perrysburg, OH (US)

Correspondence Address: HONEYWELL/CANTOR COLBURN;Patent Services, 101 Columbia Road, P.O. Box, Morristown, NJ, 07962-2245, US

(21) Appl. No.: 12/640,456

(22) Filed: Dec. 17, 2009

Related U.S. Application Data
(60) Provisional application No. 61/141,096, filed on Dec. 29, 2008.

(51) Int. Cl. B01D 15/04; B01D 33/44

(52) U.S. Cl. 210/741; 210/284; 210/137; 210/287; 210/792; 210/269

(57) ABSTRACT

An oil filtration assembly for filtering oil comprises a housing having an inlet port and an outlet port defining a flow path for oil to flow therethrough. A diatomaceous earth filtering media layer is disposed in the oil flow path, intermediate of the inlet port and the outlet port and is configured to filter soot and contaminants from oil passing through the oil filtration assembly.

### CROSS-REFERENCE TO RELATED APPLICATIONS

This application claims the benefit of U.S. Provisional Application, Ser. No. 61/141096, filed on Dec. 29, 2008, the contents of which are incorporated by reference herein.

### TECHNICAL FIELD

This application relates to an apparatus and method for removing soot from lubricating oils.

### BACKGROUND

In modern automobiles, many types of fluid filters are common. An oil filter is a fluid filter used to strain the engine oil to remove abrasive particles and other contaminants. Typical filters use a mechanical or ‘screening’ type of filtration mechanism and may employ a replaceable filter cartridge having a porous filter media through which oil is repeatedly cycled. Unfiltered engine oil enters an oil filter under pressure, passes through the filter media where contaminants are removed, and is returned to the engine's lubrication system. Effective filtering can prevent premature wear, extend the life of the engine and ensure that impurities will not circulate through the engine damaging critical components. Filtering also increases the usable life of the oil thereby reducing downtime for maintenance, as well as limiting the quantity of oil that must be discarded.

It is common in the normal operation of an internal combustion engine, particularly that of a diesel engine, to result in the formation of oil-borne contaminants. These contaminants include, among others, soot, which is formed from incomplete combustion of fossil fuels, and acids that result from combustion. These contaminants may increase oil viscosity, generate unwanted engine deposits and lead to increased engine wear. Depending on the application and the requirements of the lubrication system of the engine, the engine oil is capable of sustaining some level of suspended soot and contaminants. As the soot suspended in the oil increases during operation of the engine, the oil must be changed or damage to the engine may occur.

A conventional solution to oil contamination has been to place various chemically derived additive packages into lubricating oils during their initial formulation. In order to combat soot-related problems, many conventional lubricating oils include dispersants that resist agglomeration of soot therein. Such additives work well but may become depleted after extended engine operation. Additionally, and due to the solubility and chemical stability limits of the additives, the service life of the lubricating oil and the associated oil filter may be less than desired.

To improve the service life of the lubricating oil and the oil filter under acidic conditions resulting from combustion by-products, many conventional motor oils include neutralizing additives known as over-based detergents. These and other additives are quantified as TBN (total base number), which is a measure of the quantity of the over-based detergent in the oil, expressed in terms of the equivalent number of milligrams of potassium hydroxide that is required to neutralize all basic constituents present in 1 gram of sample. Higher TBN oils provide longer lasting acid neutralization. The depletion of TBN is an important limiting factor for lubricants in many internal combustion engines and, in particular, for heavy-duty applications with diesel engines.

Additionally, conventional lubricating oils often include one or more further additives, which may include corrosion inhibitors, antioxidants, friction modifiers, pour point depressants, detergents, viscosity index improvers, anti-wear agents, and/or extreme pressure additives. The inclusion of these further additives may be beneficial however; the amount and concentration of these additives are limited by the ability of the base lubricating oil to suspend the additives, as well as by the chemical stability of the additives in the oil.

In addition to trapping impurities in contaminated oil, the oil filter must ensure fast and efficient flow through its media. Continuous oil flow is essential for proper lubrication of engine components and the prevention of friction, heat and wear. Engine components rely on the oil circulation system to deliver a continuous, reliable and adequate supply of motor oil.

Accordingly, it is desirable to provide a method and apparatus for removing soot and other contaminants from the oil in a manner that will extend both the operational life of the oil and the filter, as well as the engine with which they are associated.

### SUMMARY

In an exemplary embodiment, an oil filtration assembly for filtering oil comprises a housing having an inlet port and an outlet port defining a flow path for oil to flow therethrough. A diatomaceous earth filtering media layer is disposed in the oil flow path, intermediate of the inlet port and the outlet port and is configured to filter soot and contaminants from oil passing through the oil filtration assembly.

In another exemplary embodiment, a method of operating an oil filtration assembly for filtering oil that comprises a housing having an inlet port and an outlet port defining a flow path for oil to flow therethrough, a diatomaceous earth filtering media layer disposed in the oil flow path, intermediate of the inlet port and the outlet port and configured to filter soot and contaminants from oil passing through the oil filtration assembly, a diatomaceous earth reservoir associated with the housing and in communication with the diatomaceous earth filtering media layer, a delivery system extending between the diatomaceous earth reservoir and the housing configured to deliver diatomaceous earth particles from the diatomaceous earth reservoir to the diatomaceous earth filtering media layer, a first pressure sensor located upstream of the diatomaceous earth filtering media layer, a second pressure sensor located downstream of the diatomaceous earth filtering media layer and a controller in communication with the first and the second pressure sensors and configured to determine a pressure differential across the diatomaceous earth filtering media layer is disclosed. The method comprises monitoring the pressure differential across the diatomaceous earth filtering media layer, determining that the diatomaceous earth filtering media layer is near its soot-collection capacity and activating the delivery system to deliver diatomaceous earth particles from the diatomaceous earth reservoir to the diatomaceous earth filtering media layer to extend the filtering life of the oil filtration assembly.

### BRIEF DESCRIPTION OF DRAWINGS

The invention, in accordance with preferred and exemplary embodiments, together with further advantages thereof, is more particularly described in the following detailed description taken in conjunction with the accompanying drawings in which:

FIG. 1 is a schematic diagram of an oil filtration system embodying features of the present invention;

FIG. 2 is a schematic diagram of the oil filtration system of FIG. 1 in a second mode of operation;

FIG. 3 is plot illustrating performance characteristics of an embodiment of the invention; and

FIG. 4 is a schematic diagram of another embodiment of an oil filtration system of the present invention.

### DESCRIPTION OF EXEMPLARY EMBODIMENTS

A limitation to the use of additive packages in lubricating oils to resist agglomeration of soot therein is that the service lives of the lubricating oil and the oil filter are limited by the solubility and chemical stability limits of the dispersants. In accordance with an exemplary embodiment of the present invention, methods and apparatus are directed to an oil filtration assembly having, as a component, a diatomaceous earth filtering media layer configured to remove soot from engine lubricating oil. The filtering media layer operates to trap soot and other contaminants within a void volume of the diatomaceous earth particles disposed therein. The extremely small pore structures inherent in diatomaceous earth are effective to remove very small particles from the engine's lubricating oil. The oil filtration assembly monitors soot accumulation in the diatomaceous earth filtering media layer by measuring the pressure drop across the layer. Additional diatomaceous earth filtering media may periodically be added to the diatomaceous earth filtering media layer as the existing layer begins to its reach soot-collection capacity. The addition of diatomaceous earth to the filtering media layer substantially extends the filtering life of the oil filtration assembly. Removal of soot and contaminants from the oil using the diatomaceous earth filtering media layer also extends the useful life of the oil additive packages, thus increasing the service life of the lubricating oil and the oil filter while providing continuous oil flow through the filter and the lubrication system of the engine.

In one exemplary embodiment, the oil filtration assembly may include a diatomaceous earth reservoir configured to automatically dispense additional diatomaceous earth filtering media to increase the soot-collection capacity as the diatomaceous earth filtering media layer becomes saturated.

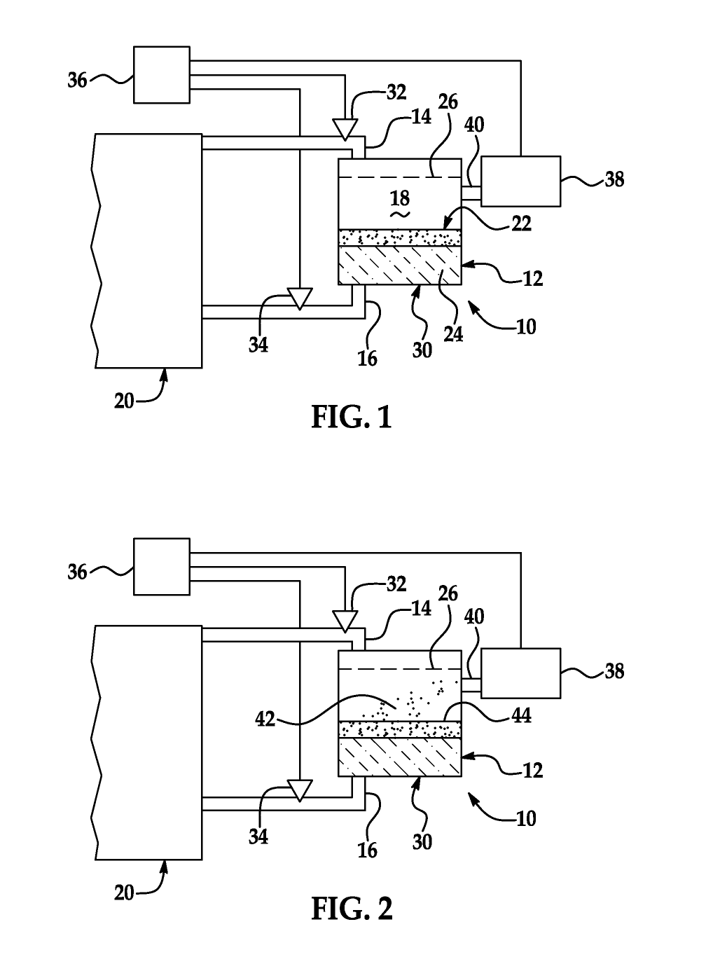

In one exemplary embodiment shown in FIG. 1, an oil filtration assembly 10 is defined by a housing 12 having an inlet port 14 and an outlet port 16. The housing 12 is configured to receive oil 18 under pressure from the lubrication system of an internal combustion engine 20. Disposed within the oil filter housing 12 intermediate of the inlet port 14 and the outlet port 16 is a diatomaceous earth filtering media layer 22. The diatomaceous earth filtering media layer 22 is disposed in a manner that forces the oil 18 to flow through the diatomaceous earth where soot and other contaminants are trapped in void volumes within the diatomaceous earth particles 24. In a non-limiting embodiment, at least one additional filter media such as fiber media 26 may be disposed within the filter housing and within the oil flow path. The additional filter media may be disposed upstream of the diatomaceous earth filtering media layer 22 and configured as a pre-filter or down stream of the filtering media layer 22 and configured as a final filter in advance of returning the oil 18 to the lubrication system of the internal combustion engine 20.

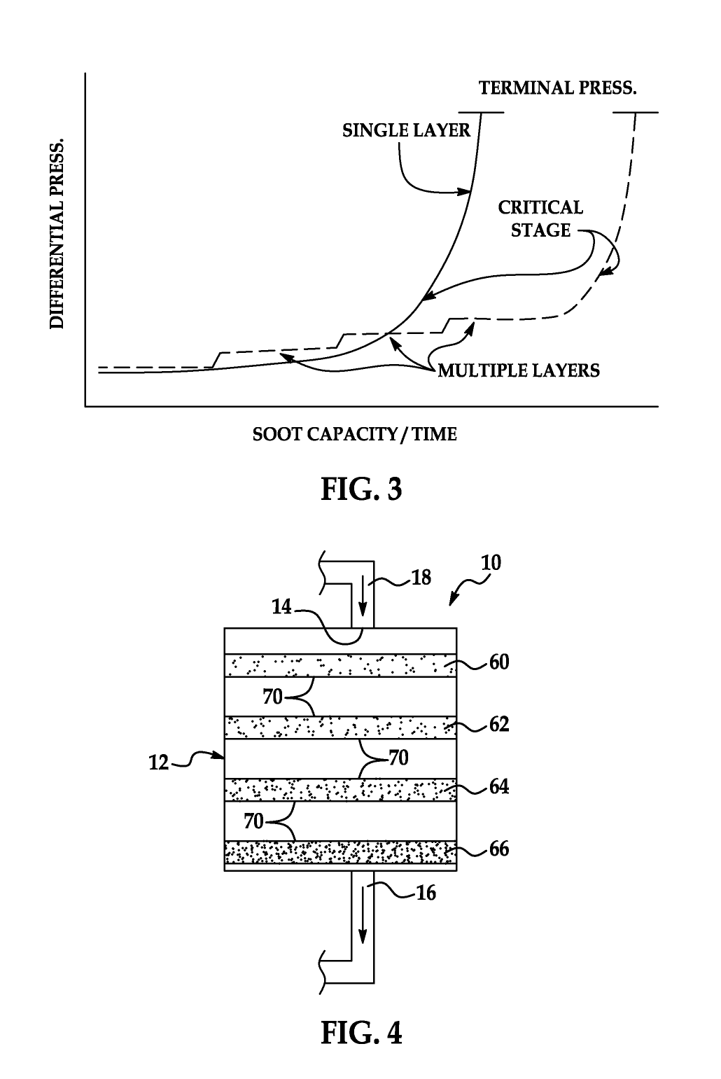

In one exemplary embodiment, the diatomaceous earth filtering media layer 22 is disposed adjacent to the outlet end 30 of the housing 12 proximate to outlet port 16. Advantageously, diatomaceous earth particles 24 have extremely small pore structures and can filter out very small particles of soot and other containments. As the diatomaceous earth particles reach soot collection capacity, an increase in backpressure may occur rapidly once a critical stage, FIG. 3, is reached. A critical stage is determined when backpressure across the diatomaceous earth filtering media layer 22 rapidly increases due to the diatomaceous earth particles 24 within the filtering layer nearing soot-collection capacity. When contaminants such as soot can no longer be removed from the engine oil 18, the service life of the lubricating oil and components of the oil filter assembly 10 will decrease, resulting in non-continuous oil flow through the lubrication system of the engine 20 which could necessitate a replacement of the oil filtration assembly, or components thereof. First and second pressure sensors 32 and 34, respectively, may be located at upstream and at downstream locations of the diatomaceous earth filtering media layer 22. The pressure sensors 32, 34 are configured to generate signals indicative of the oil system pressure at their respective locations and send the signals to a controller 36 that is configured to determine a pressure differential across the filtering media layer 22.

In an exemplary embodiment, the oil filtration assembly 10 includes a diatomaceous earth reservoir 38 and delivery system 40 that is associated with the filter housing 12 and in communication with the diatomaceous earth filtering media layer 22. As a critical stage of oil pressure or as a pressure differential across the filtering media layer 22 is approached within the oil filtration assembly 10, as determined by controller 36, the controller commands the delivery system 40 to dispense additional diatomaceous earth particles 42 into the housing 12, preferably upstream of the existing layer 22. The additional diatomaceous earth particles 42, FIG. 2, define an additional diatomaceous earth filtering media layer 44 that effectively extends the filtering capacity of the diatomaceous earth filtering media layer 22 by avoiding or delaying a critical pressure differential thereacross. The delivery system 40 may employ a releasing mechanism, such as an auger (not shown), to dispense the additional diatomaceous earth particles 42 incrementally, continuously or as determined by measuring the increasing differential pressure across the filtering layer.

It will be appreciated that as additional diatomaceous earth 42 is dispensed, soot collection capacity will be increased due to the added void volume thereof. By adding additional diatomaceous earth particles 42, the soot-collection capacity within the diatomaceous earth filtering media layer is increased, and incidentally, the time interval for the differential pressure to reach the critical stage increases.

In another non-limiting exemplary embodiment shown in FIG. 4, in which like numbers denote like features already described, multiple layers 60, 62, 64, 66 of diatomaceous earth particles 24 are disposed within the housing 12 of the oil filtration assembly 10. Each layer comprises diatomaceous earth particles that may be supported by a structure such as mesh 70 that is configured to rigidly support the respective layers within the housing 12. The series of diatomaceous earth layers 60, 62, 64, 66 allows soot to be more efficiently collect within the void volume of the diatomaceous earth particles 24 by increasing the total surface area available for oil filtration. In an exemplary embodiment, each diatomaceous earth layer may be configured to have a different pore structure, wherein the layer 60, which is closest to the inlet port 14, has the highest porosity, and the diatomaceous layer 66, which is closest to the outlet port 16, has the lowest porosity. The order of decreasing porosity in the direction of the flow of oil 18 prevents the diatomaceous layers 60, 62, 64, 66 from prematurely reaching a critical pressure differential stage by allowing the highest porosity layers 60, 62 to remove larger particles of soot and contamination from the oil 18 prior to filtration of the oil by the lowest porosity layers 64, 66.

This written description uses examples to disclose the invention, including the best mode, and also to enable a person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An oil filtration assembly for filtering oil comprising:
a housing having an inlet port and an outlet port defining a flow path for oil to flow therethrough;
a diatomaceous earth filtering media layer disposed in the oil flow path, intermediate of the inlet port and the outlet port and configured to filter soot and contaminants from oil passing through the oil filtration assembly.

2. The oil filtration assembly of claim 1, further comprising;
a diatomaceous earth reservoir associated with the housing and in communication with the diatomaceous earth filtering media layer;
a delivery system extending between the diatomaceous earth reservoir and the housing configured to deliver diatomaceous earth particles from the diatomaceous earth reservoir to the diatomaceous earth filtering media layer.

3. The oil filtration assembly of claim 2, further comprising a first pressure sensor located upstream of the diatomaceous earth filtering media layer;
a second pressure sensor located downstream of the diatomaceous earth filtering media layer; and
a controller in communication with the first and the second pressure sensors and configured to determine a pressure differential across the diatomaceous earth filtering media layer and to operate the delivery system, when a predetermined pressure differential value is reached.

4. The oil filtration assembly of claim 3, wherein the predetermined pressure differential value is related to the soot-collection capacity of the diatomaceous earth filtering media layer.

5. The oil filtration assembly of claim 1, further comprising;
a second diatomaceous earth filtering media layer disposed in the oil flow path in spaced relationship to the diatomaceous earth filtering media layer and configured to filter soot and contaminants from oil passing through the oil filtration assembly.

6. The oil filtration assembly of claim 5, further comprising mesh-like supporting structures configured to support the diatomaceous earth filtering media layers in spaced relationship.

7. The oil filtration assembly of claim 6, the second diatomaceous earth filtering media layer configured with a porosity that varies from the porosity of the diatomaceous earth filtering media layer.

8. A method of operating an oil filtration assembly for filtering oil that comprises a housing having an inlet port and an outlet port defining a flow path for oil to flow therethrough, a diatomaceous earth filtering media layer disposed in the oil flow path, intermediate of the inlet port and the outlet port and configured to filter soot and contaminants from oil passing through the oil filtration assembly, a diatomaceous earth reservoir associated with the housing and in communication with the diatomaceous earth filtering media layer, a delivery system extending between the diatomaceous earth reservoir and the housing configured to deliver diatomaceous earth particles from the diatomaceous earth reservoir to the diatomaceous earth filtering media layer, a first pressure sensor located upstream of the diatomaceous earth filtering media layer, a second pressure sensor located downstream of the diatomaceous earth filtering media layer and a controller in communication with the first and the second pressure sensors and configured to determine a pressure differential across the diatomaceous earth filtering media layer comprising:
monitoring the pressure differential across the diatomaceous earth filtering media layer;
determining that the diatomaceous earth filtering media layer is near its soot-collection capacity; and
activating the delivery system to deliver diatomaceous earth particles from the diatomaceous earth reservoir to the diatomaceous earth filtering media layer to extend the filtering life of the oil filtration assembly.
